(19) United States
(12) Patent Application Publication
(10) Pub. No.: US 2009/0237567 A1
(43) Pub. Date: Sep. 24, 2009

(54) Method and apparatus for emitting ambient light corresponding to display image on display device

(76) Inventor: Walter Tsao, Lujhu Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/379,838

(22) Filed: Mar. 3, 2009

(30) Foreign Application Priority Data
Mar. 21, 2008 (CN) 200810026968.6

(51) Int. Cl. H04N 5/58; G09G 3/32

(52) U.S. Cl. 348/602; 345/83; 348/E05.119

(57) ABSTRACT

A method for emitting an ambient light corresponding to a display image on a display device includes the following steps. A color parameter group is extracted from overall pixels of a frame, an average color and/or an average brightness corresponding to the frame are/is obtained by calculating the color parameter group, and an ambient light corresponding to the average color and/or the average brightness is emitted according to the average color and/or the average brightness.

### CROSS-REFERENCE TO RELATED APPLICATIONS

This non-provisional application claims priority under 35 U.S.C. §119(a) on Patent Application No(s). 200810026968.6 filed in China, P.R.C. on Mar. 21, 2008 the entire contents of which are hereby incorporated by reference.

### BACKGROUND OF THE INVENTION

1. Field of Invention

The present invention relates to a method and an apparatus for emitting an ambient light, in particular, to a method and an apparatus for emitting an ambient light corresponding to a display image on a display device.

2. Related Art

Currently, with the development and maturity of display technology, higher requirements on the visual effect are put forward. The most common display device in the market such as liquid crystal display (LCD) TV set is merely pursuing display images with the vivid colors and high definition. However, the light emitted by the device or the backlight source has a low brightness and a simplex color, such that, instead of giving people a better visual effect, the device may easily cause the eye fatigue. People is willing to be personally on the scene when watching TV, movie, or other programs. If the display device may emit an ambient light having a color and brightness corresponding the color of the display images, a better visual effect may be brought to the people, such that people may feel to be personally on the scene and the eye fatigue may be alleviated. Therefore, the method and apparatus for emitting an ambient light corresponding to a display image on a display device which is applied to the display device is an objective where technique developers will pay more efforts currently.

### SUMMARY OF THE INVENTION

The present invention is directed to a method and an apparatus for emitting an ambient light corresponding to a display image on a display device, for solving the problem of light emitting.

The method for emitting an ambient light corresponding to a display image on a display device includes the following steps. A color parameter group is extracted from overall pixels of a frame, an average color and/or an average brightness corresponding to the frame are/is obtained by calculating the color parameter group, and an ambient light corresponding to the average color and/or the average brightness is emitted according to the average color and/or the average brightness.

The present invention is also directed to an apparatus for emitting an ambient light corresponding to a display image on a display device, which includes a receiving unit, for extracting a color parameter group from overall pixels of a frame; a calculation unit, for calculating the color parameter group to obtain an average color and/or an average brightness corresponding to the frame; and an ambient light unit, having a light emitting element for emitting an ambient light corresponding to the average color and/or the average brightness.

The apparatus for emitting an ambient light corresponding to a display image on a display device provided in the present invention may extract a color parameter group from overall pixels in a frame, calculate the color parameter group to obtain an average color and/or an average brightness corresponding to the frame, and finally emit the ambient light corresponding to the average color and/or the average brightness according to the average color and/or the average brightness. Thus, when the display device displays display images, the apparatus of the present invention may emit an ambient light corresponding to the average color and brightness of the displayed display image, such that the user may enjoy a better visual effect on the display images.

### BRIEF DESCRIPTION OF THE DRAWINGS

The present invention will become more fully understood from the detailed description given herein below for illustration only, and thus are not limitative of the present invention, and wherein:

FIG. 1 is a schematic view of an apparatus for emitting an ambient light corresponding to a display image on a display device;

FIG. 2 is a schematic view of the apparatus of the present invention coupled to a display device;

FIG. 3 is a schematic view of the apparatus of the present invention emitting an ambient light corresponding to a display image on a display device; and

FIG. 4 is a flow chart of a method of the present invention.

### DETAILED DESCRIPTION OF THE INVENTION

Features and advantages of the present invention are illustrated in the following detailed description of the present invention in detail, which are sufficient for persons skilled in the art to understand the technical content of the present invention, and implement thereby. According to the disclosure of the specification, claims, and drawings, any person skilled in the art may easily understand the objective and advantage of the present invention. Hereinafter, the embodiments are provided for further illustrating the viewpoints of the present invention, instead of intending to limit the scope of the present invention with any viewpoint.

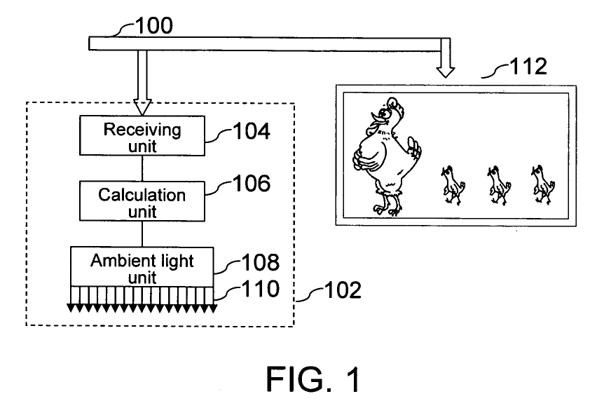

FIG. 1 is a schematic view of an apparatus for emitting an ambient light corresponding to a display image on a display device. The apparatus for emitting an ambient light corresponding to a display image on a display device 102 in the present invention includes a receiving unit 104, for receiving a video signal 100 as received by the display device 112, and obtaining a color parameter group from overall pixels of a frame; a calculation unit 106, calculating the color parameter to obtain an average color or an average brightness corresponding to the frame, or obtain the average color and the average brightness at the same time; and an ambient light unit 108, having a light emitting element such as a light emitting diode (LED) for emitting an ambient light 110 corresponding to the average color and/or the average brightness.

That is to say, the apparatus of the present invention may receive, calculate, and convert the video signal, and finally emit the ambient light corresponding to the average color and/or brightness of the display image by the, i.e., the ambient light changes along with the different display images. Therefore, since the emitted ambient light is corresponding to the average color and/or brightness of the display image, the ambient light has a color close to the major color of the display image, such that the viewer may enjoy a better visual effect by means of the ambient light.

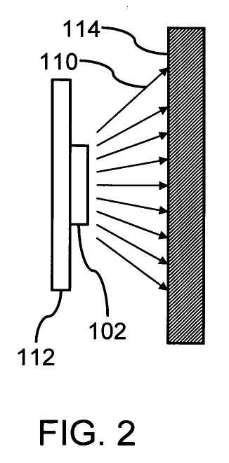

The apparatus of the present invention may be coupled to the display device by means of an external box or a built-in module. FIG. 2 is a schematic view of the apparatus of the present invention coupled to a display device by means of an external box. In FIG. 2, the apparatus for emitting an ambient light corresponding to a display image on a display device 102 in the present invention is disposed at a center of the rear portion of the display device 112, and the ambient light 110 emitted by the apparatus for emitting an ambient light corresponding to a display image on a display device 102 of the present invention is irradiated onto a wall 114, so as to strengthen the ambient light.

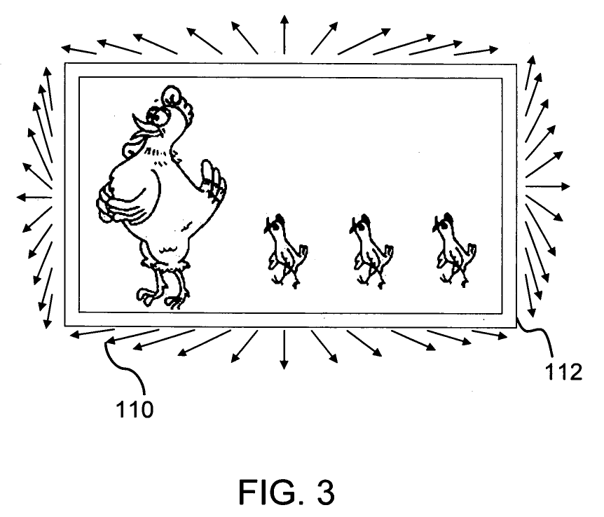

FIG. 3 is a schematic view of the apparatus of the present invention emitting an ambient light corresponding to a display image on a display device. The apparatus in the present invention may emit the ambient light 110 corresponding to the content displayed by the display device 112.

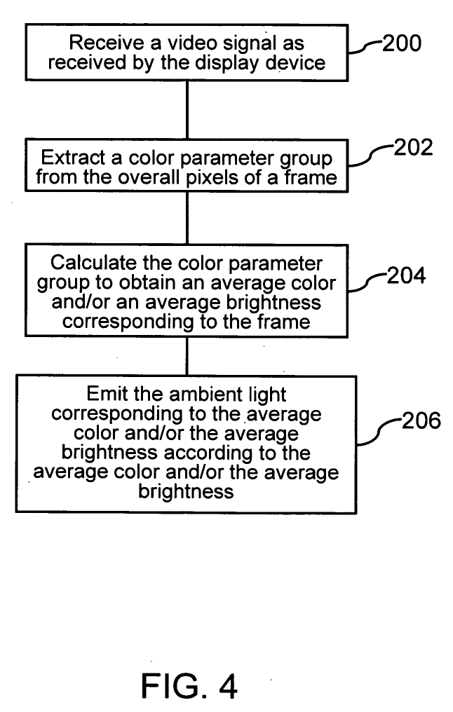

FIG. 4 is a flow chart of a method of the present invention. In Step 200, the receiving unit 104 receives the video signal 100 as received by the display device, and then in Step 202, the receiving unit 104 extracts a color parameter group from the overall pixels of a frame included in the video signal. In this embodiment, the color parameter group is a red green blue (RGB) coordinate group. After that, in Step 204, the calculation unit 106 calculates the color parameter group to obtain an average color and/or an average brightness corresponding to the frame. In detail, in this embodiment, the RGB coordinate group is converted into a lightness chroma hue (LCH) coordinate group, and then the overall hue (H) coordinates are accumulated to obtain an accumulated value (HSUM). The accumulated value (HSUM) is divided by a resolution of the frame to obtain an average value (HAVG) of the hue (H) coordinate. Then, the average value (HAVG) is converted by the calculation unit 106 to obtain an average color and/or an average brightness corresponding to the frame. Finally, in Step 206, a light emitting element in the ambient light unit 108 is driven according to the average color and/or the average brightness to emit the ambient light 110 corresponding to the average color and/or the average brightness.

The present invention has been disclosed above by the preferred embodiments, and any equivalent modifications and variations without departing from the spirit and scope of the present invention will fall within the scope covered by the patent of the present invention.

What is claimed is:

1. A method for emitting an ambient light corresponding to a display image on a display device, comprising:
extracting a color parameter group from overall pixels of a frame;
calculating the color parameter group to obtain an average color and/or an average brightness corresponding to the frame; and
emitting an ambient light corresponding to the average color and/or the average brightness according to the average color and/or the average brightness.

2. The method for emitting an ambient light corresponding to a display image on a display device according to claim 1, before extracting a color parameter group from overall pixels of a frame, further comprising receiving a video signal as received by the display device.

3. The method for emitting an ambient light corresponding to a display image on a display device according to claim 1, wherein the process of calculating the color parameter group to obtain an average color and/or an average brightness corresponding to the frame comprises:
converting the color parameter group into a lightness chroma hue (LCH) coordinate group;
calculating an average value (H_{AVG}) of a hue coordinate (H) in the LCH coordinate group; and
converting the average value (H_{AVG}) to obtain the average color and/or the average brightness corresponding to the frame.

4. The method for emitting an ambient light corresponding to a display image on a display device according to claim 3, wherein the process of calculating an average value (H_{AVG}) of a hue coordinate (H) in the LCH coordinate group comprises:
accumulating the overall hue coordinates (H) to obtain an accumulated value (H_{SUM}); and
dividing the accumulated value (H_{SUM}) by a resolution of the frame to obtain the average value (H_{AVG}) of the hue coordinate (H).

5. The apparatus for emitting an ambient light corresponding to a display image on a display device, comprising:
a receiving unit, for extracting a color parameter group from overall pixels of a frame;
a calculation unit, calculating the color parameter group to obtain an average color and/or an average brightness corresponding to the frame; and
an ambient light unit, having a light emitting element for emitting an ambient light corresponding to the average color and/or the average brightness.

6. The apparatus for emitting an ambient light corresponding to a display image on a display device according to claim 5, wherein the light emitting element is an LED.
